(19) United States
(12) Patent Application Publication
(10) Pub. No.: US 2004/0013494 A1
(43) Pub. Date: Jan. 22, 2004

(54) Fastener having solid driving structure

(76) Inventor: Chang Hui Lin, Chang Hua Hsien (TW)

Correspondence Address: CHARLES E. BAXLEY, 5th Floor, 59 John Street, New York, NY, 10038, US

(21) Appl. No.: 10/198,834

(22) Filed: Jul. 22, 2002

(51) Int. Cl. F16B 23/00

(52) U.S. Cl. 411/403

(57) ABSTRACT

A fastener includes a head, and a shank extended from the head and formed integral with the head. The shank includes an outer peripheral portion having an outer thread formed along a portion or formed through the length of the shank. The fastener includes a socket cavity formed in both the head and the shank, for receiving the driving tools, and for allowing both the head and the shank to be solidly driven by the driving tools. The socket cavity may be formed in a portion of the shank, but may also be formed through the shank.

### BACKGROUND OF THE INVENTION

1. Field of the Invention

The present invention relates to a fastener, and more particularly to a fastener, such as a screw, a bolt, or the like, having a solid driving or driven structure.

2. Description of the Prior Art

Typical fasteners, such as screws, bolts, or the like, comprise a head having a threaded shank extended from the head for engaging into the objects to be secured or fastened. The head includes a socket cavity formed therein for receiving the driving shank or stem of the driving tools, and for allowing the fastener to be rotated or driven by the driving tools.

U.S. Pat. No. 5,171,117 to Seidl, and U.S. Pat. No. 5,868,536 to Nojikawa disclose two of the typical fasteners each having a socket cavity formed in the head for receiving the driving shank or stem of the driving tools.

However, the socket cavities are normally formed only in the head of the typical fasteners, such as the screws, the bolts, or the like, such that the driving shank or stem of the driving tool may only be engaged into the head of the fastener, and may not be engaged into the threaded shank of the fastener, and such that the head may be broken and disengaged from the threaded shank, if an over load is applied to the head of the fastener.

The present invention has arisen to mitigate and/or obviate the afore-described disadvantages of the conventional fasteners.

### SUMMARY OF THE INVENTION

The primary objective of the present invention is to provide a fastener, such as a screw, a bolt, or the like, having a solid driving or driven structure, for allowing the fastener to be solidly rotated or driven by the driving tools.

In accordance with one aspect of the invention, there is provided a fastener comprising a head, and a shank extended from the head and formed integral with the head, the shank including an outer peripheral portion having an outer thread formed thereon, and the fastener including a socket cavity formed in the head and in the shank, for receiving a driving tool, and for allowing both the head and the shank to be solidly driven by the driving tool.

The outer thread may be formed on a portion or formed along the length of the outer peripheral portion of the shank. The socket cavity may be formed in a portion of the shank, but may also be formed through the shank.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a fastener in accordance with the present invention;

FIG. 2 is a plan view of the fastener; and

FIG. 3 is a partial cross sectional view illustrating the operation or the driven of the fastener by the driving tool.

### DETAILED DESCRIPTION OF THE PREFERRED EMBODIMENT

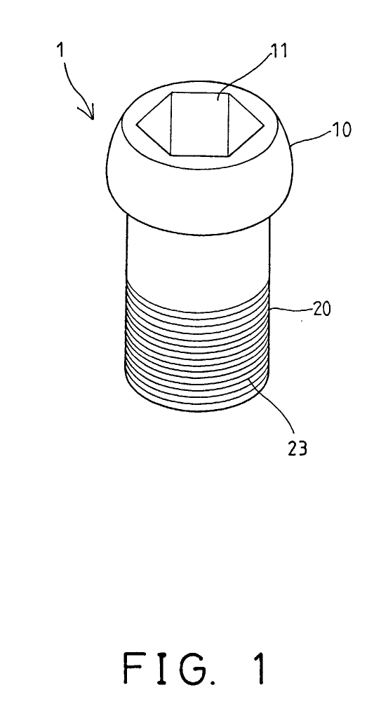

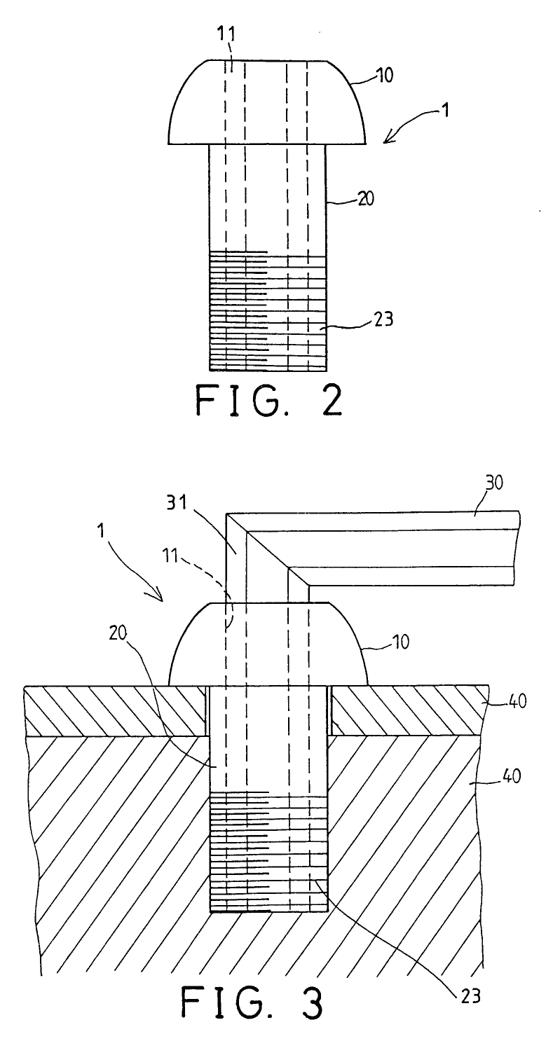

Referring to the drawings, and initially to FIGS. 1 and 2, a fastener 1 in accordance with the present invention comprises a head 10, and a shank 20 extended from the head 10, and formed as a one-integral-piece with the head 10. The fastener 1 may be the screw, the bolt, or the like.

The shank 20 includes an outer thread 23 formed on the lower portion of the outer peripheral portion of the shank 20, or formed along the length of the shank 20, for engaging into the objects 40 (FIG. 3) to be fastened with the fastener 1.

The fastener 1 further includes a socket cavity 11 formed in the head 10, and simultaneously formed or provided in the shank 20, for receiving the driving stem 31 of the driving tool 30, and for allowing the fastener 1 to be solidly rotated or driven by the driving tool 30.

The socket cavity 11 of the fastener 1 may be formed into a portion of the shank 20, or preferably be formed through the length of the shank 20. The socket cavity 11 of the fastener 1 may include a non-circular cross section, such as a square, a rectangular, a hexagonal cross section, or the like, for receiving the driving stem 31 of the driving tool 30.

In operation, as shown in FIG. 3, the driving stem 31 of the driving tool 30 may be engaged into the shank 20, such as engaged into a portion of the shank 20, or engaged through the shank 20, such that the fastener 1 may be solidly rotated or driven by the driving stem 31 of the driving tool 30.

Accordingly, the fastener in accordance with the present invention includes a solid driving or driven structure, for allowing the fastener to be solidly rotated or driven by the driving tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener comprising:
a head, and a shank extended from said head and formed integral with said head,
said shank including an outer peripheral portion having an outer thread formed thereon, and
said fastener including a socket cavity formed in said head and in said shank, for receiving a driving tool, and for allowing both said head and said shank to be driven by the driving tool.

2. The fastener according to claim 1, wherein said outer thread is formed on a portion of said outer peripheral portion of said shank.

3. The fastener according to claim 1, wherein said socket cavity is formed through said shank.
